(19) United States
(12) Patent Application Publication
(10) Pub. No.: US 2011/0080463 A1
(43) Pub. Date: Apr. 7, 2011

(54) IMAGE PROCESSING APPARATUS, METHOD, AND RECORDING MEDIUM

(75) Inventors: Hisashi ENDO, Saitama-shi (JP); Hideaki Kokubun, Saitama-shi (JP)

(73) Assignee: FUJIFILM Corporation, Tokyo (JP)

(21) Appl. No.: 12/898,607

(22) Filed: Oct. 5, 2010

(30) Foreign Application Priority Data
Oct. 7, 2009 (JP) JP2009-233432

(51) Int. Cl. H04N 13/00

(52) U.S. Cl. 348/42

(57) ABSTRACT

An image processing method executed in an apparatus, includes steps of: inputting a left-viewpoint image and a right-viewpoint image therebetween to the apparatus; searching for a corresponding point in the right-viewpoint image with respect to the left-viewpoint image, generating a first corresponding-point map based on a result of the searching, and generating a first intermediate-viewpoint image based on the left-viewpoint image; searching for a corresponding point in the left-viewpoint image with respect to the right-viewpoint image, generating a second corresponding-point map based on a result of the searching, and generating a second intermediate-viewpoint image based on the right-viewpoint image; extracting missing portions of pixels in the first and second intermediate-viewpoint images; determining whether a missing portion extracted is a missing portion to be interpolated or not; interpolating the missing portion to be interpolated based on a result of determination; and generating a third intermediate-viewpoint image based on the intermediate-viewpoint images.

### BACKGROUND OF THE INVENTION

1. Field of the Invention

The presently disclosed subject matter relates to an image processing apparatus, a method, and a recording medium. More particularly, the presently disclosed subject matter relates to an image processing apparatus, a method, and a recording medium which are configured to reduce unevenness in color in a final intermediate-viewpoint image caused by pixels being present only in one of a plurality of intermediate-viewpoint images.

2. Description of the Related Art

A technique to generate an image corresponding to an arbitrary intermediate viewpoint from two images with different viewpoints that are taken as a stereo image is important for preparing a stereoscopic photoprint with a lenticular lens sheet attached on a surface thereof or displaying an appropriate stereo image on various types of a stereo image display device.

To generate images corresponding to an intermediate viewpoint (intermediate-viewpoint images), with two images taken from different viewpoints, a search (stereo matching) is performed for pixels in a right-viewpoint image (a right image) R that correspond to pixels in a left-viewpoint image (a left image) L to generate a corresponding-point map ML that maps corresponding points of pixels between the two images. In a similar manner, a corresponding-point map MR for individual pixels is generated through a search for corresponding points from R to L.

Then, forward mapping is performed to move the pixels in the left image L according to the map ML to generate an intermediate-viewpoint image IL that is based on the left image L. Similarly, forward mapping to move the pixels in the right image R according to the map MR is performed to generate an intermediate-viewpoint image IR that is based on the right image R.

For example, as depicted in FIG. 9, the intermediate-viewpoint image based on the left image L is derived by moving pixels A, B, and C in the left image L by amounts of movement DA, DB, and DC, respectively. In this process, DA, DB, and DC can be calculated by multiplying the amount of movement for each pixel which is calculated from the map ML according to the position of the intermediate viewpoint to be determined by a certain coefficient. By way of example, when the intermediate viewpoint is the midpoint between L and R, the coefficient will be 0.5, and the product of the distance from pixel A to its corresponding point (i.e., the amount of movement) and 0.5 will be the amount of movement DA. When the amounts of movement for neighboring pixels are different in forward mapping, a missing portion can occur in the result of mapping. In the example illustrated in FIG. 9, the area illustrated as Z between B and C in the intermediate-viewpoint image represents such a missing portion.

By combining the intermediate-viewpoint images IL and IR thus obtained, an accurate intermediate-viewpoint image as the final result is produced. The final result is obtained by weighted-averaging the respective pixels of the intermediate-viewpoint images IL and IR according to the position of the intermediate viewpoint. When there is a missing portion as a result of mapping in one of the intermediate-viewpoint images, pixel values from the other image that has no missing portion will be used as they are. However, when there is a difference in brightness or color in the left image L and the right image R which are the original images, a difference in color would occur between a region in which pixel values of both the intermediate-viewpoint images are weighted-averaged and a region in which pixels value from only one of the images are used because pixels are present only in that intermediate-viewpoint image. Such a difference in color will cause unevenness in color in the final intermediate-viewpoint image.

As a conventional way to obtain an intermediate-viewpoint image having no such a missing portion, an art described in Japanese Patent Application Laid-Open No. 2006-65862 obtains an intermediate-viewpoint image with no missing portion from the left (or right) image by deriving a first parallax map from left to right (or right to left) by stereo matching, deriving a second parallax map for the position of the intermediate viewpoint by forward-mapping the first parallax map, and further performing reverse mapping using the second parallax map.

### SUMMARY OF THE INVENTION

The art described in Japanese Patent Application Laid-Open No. 2006-65862, however, is disadvantageous in that it requires two mapping computations for obtaining one intermediate-viewpoint image, involving high computation load.

The presently disclosed subject matter has been made in view of such circumstances, and an object thereof is to provide an image processing apparatus, a method, and a recording medium which are configured to reduce unevenness in color in a final intermediate-viewpoint image arising from presence of pixels only in one of a plurality of intermediate-viewpoint images.

To attain the object, a first aspect of the presently disclosed subject matter provides an image processing method executed in an image processing apparatus, including: an image input step of inputting a left-viewpoint image and a right-viewpoint image that have a parallax therebetween to the image processing apparatus; a step of searching for a corresponding point in the right-viewpoint image for each pixel with respect to the left-viewpoint image, generating a first corresponding-point map based on a result of the searching, and generating a first intermediate-viewpoint image which is based on the left-viewpoint image by forward mapping performed according to the first corresponding-point map; a step of searching for a corresponding point in the left-viewpoint image for each pixel with respect to the right-viewpoint image, generating a second corresponding-point map based on a result of the searching, and generating a second intermediate-viewpoint image which is based on the right-viewpoint image by forward mapping performed according to the second corresponding-point map; an extracting step of extracting missing portions of pixels in the first and second intermediate-viewpoint images, the missing portions being caused by absence of corresponding pixels in the forward mapping; a determination step of determining whether a missing portion extracted is a missing portion to be interpolated or not; an interpolating step of interpolating the missing portion to be interpolated based on a result of determination in the determination step; and a step of generating a third intermediate-viewpoint image based on the first and second intermediate-viewpoint images.

According to the first aspect, missing portions that have occurred due to absence of corresponding pixels in the forward mapping is extracted in the first and second intermediate-viewpoint images and only missing portions that should be interpolated are interpolated. This can reduce unevenness in color in the third intermediate-viewpoint image generated from the first and second intermediate-viewpoint images.

A second aspect of the presently disclosed subject matter provides an image processing method according to the first aspect, wherein the determination step determines, for a first missing portion in the first intermediate-viewpoint image, whether the first missing portion is a missing portion to be interpolated based on an image characteristic of a predetermined region in the second intermediate-viewpoint image, and the determination step determines, for a second missing portion in the second intermediate-viewpoint image, whether the second missing portion is a missing portion to be interpolated based on an image characteristic of a predetermined region in the first intermediate-viewpoint image.

It is thereby possible to determine whether missing portions in the first and second intermediate-viewpoint images are missing portions that should be appropriately interpolated or not.

A third aspect of the presently disclosed subject matter provides an image processing method according to the second aspect, wherein the predetermined regions in the first and second intermediate-viewpoint image are regions corresponding to the first and second missing portions, respectively.

This enables determination of whether the missing portion should be appropriately interpolated or not.

A fourth aspect of the presently disclosed subject matter provides an image processing method according to the second aspect, wherein the predetermined regions in the first and second intermediate-viewpoint image are regions corresponding to the first and second missing portions and a surrounding regions of the first and second missing portions, respectively, and the interpolating step interpolates the first and second missing portions using pixels in a regions corresponding to the surrounding region thereof, respectively.

This enables determination of whether the missing portion should be appropriately interpolated or not and enables appropriate interpolation of the missing portion.

A fifth aspect of the presently disclosed subject matter provides an image processing method according to any one of the second to fourth aspects, wherein the image characteristic is a variance or standard deviation of pixel values of pixels, or a difference between a maximum and a minimum of pixel values of the pixels.

This enables determination of whether the missing portion should be appropriately interpolated or not.

A sixth aspect of the presently disclosed subject matter provides an image processing method according to any one of the second to fourth aspects, wherein the image characteristic is a variance or standard deviation of pixel values of pixels at a predetermined interval, or a difference between a maximum and a minimum of pixel values of pixels at a predetermined interval.

This enables determination of whether the missing portion should be appropriately interpolated or not.

A seventh aspect of the presently disclosed subject matter provides an image processing method according to any one of the first to sixth aspects, wherein the determination step determines whether the missing portion extracted is a missing portion to be interpolated or not according to a size of the missing portion.

This enables determination of whether the missing portion should be appropriately interpolated or not.

An eighth aspect of the presently disclosed subject matter provides an image processing method according to the seventh aspect, wherein the determination step determines whether the missing portion extracted is a missing portion to be interpolated or not based on the size of the missing portion, and among missing portions to be interpolated as determined in the determination step, for a first missing portion in the first intermediate-viewpoint image, the determination step further determines whether the first missing portion is a missing portion to be interpolated or not based on an image characteristic of a predetermined region in the second intermediate-viewpoint image, and for a second missing portion in the second intermediate-viewpoint image, the determination step further determines whether the second missing portion is a missing portion to be interpolated or not based on an image characteristic of a predetermined region in the first intermediate-viewpoint image.

This enables determination of whether the missing portion should be appropriately interpolated or not and also reduce computation load.

A ninth aspect of the presently disclosed subject matter provides an image processing method according to any one of the first to eighth aspects, wherein the extracting step extracts a missing portion on each horizontal or vertical line in the first and second intermediate-viewpoint images, the determination step determines whether the missing portion extracted on each line is a missing portion to be interpolated or not, and the interpolating step interpolates the missing portion to be interpolated on each line using at least pixels at both ends of the missing portion.

This can simplify an interpolation process and reduce computation load.

To attain the object, a tenth aspect of the presently disclosed subject matter provides an image processing apparatus including: an image input device configured to receive an input of a left-viewpoint image and a right-viewpoint image that have a parallax therebetween; a first search device configured to search for a corresponding point in the right-viewpoint image for each pixel with respect to the left-viewpoint image, generate a first corresponding-point map based on a result of the search, and generate a first intermediate-viewpoint image which is based on the left-viewpoint image by forward mapping performed according to the first corresponding-point map; a second search device configured to search for a corresponding point in the left-viewpoint image for each pixel with respect to the right-viewpoint image, generates a second corresponding-point map based on a result of the search, and generates a second intermediate-viewpoint image which is based on the right-viewpoint image by forward mapping performed according to the second corresponding-point map; an extracting device configured to extract missing portions of pixels in the first and second intermediate-viewpoint images, the missing portions being caused by absence of corresponding pixels in the forward mapping; a determining device configured to determine whether a missing portion extracted is a missing portion to be interpolated or not; an interpolating device configured to interpolate the missing portion to be interpolated based on a result of determination by the determination device; and a generating device configured to generate a third intermediate-viewpoint image based on the first and second intermediate-viewpoint images.

To attain the object, an eleventh aspect of the presently disclosed subject matter provides a computer-readable recording medium (non-transitory tangible media) including an image processing program stored thereon, such that when the image processing program is read and executed by a processor of an image processing apparatus, the processor is configured to execute: an image input function of inputting a left-viewpoint image and a right-viewpoint image that have a parallax therebetween to the image processing apparatus; a function of searching for a corresponding point in the right-viewpoint image for each pixel with respect to the left-viewpoint image, generating a first corresponding-point map based on a result of the searching, and generating a first intermediate-viewpoint image which is based on the left-viewpoint image by forward mapping performed according to the first corresponding-point map; a function of searching for a corresponding point in the left-viewpoint image for each pixel with respect to the right-viewpoint image, generating a second corresponding-point map based on a result of the searching, and generating a second intermediate-viewpoint image which is based on the right-viewpoint image by forward mapping performed according to the second corresponding-point map; an extracting function of extracting missing portions of pixels in the first and second intermediate-viewpoint images, the missing portions being caused by absence of corresponding pixels in the forward mapping; a determination function of determining whether a missing portion extracted is a missing portion to be interpolated or not; an interpolating function of interpolating the missing portion to be interpolated based on a result of determination by the determination function; and a function of generating a third intermediate-viewpoint image based on the first and second intermediate-viewpoint images.

According to the presently disclosed subject matter, it is possible to reduce unevenness in color in a final intermediate-viewpoint image caused by pixels being present only in one of intermediate-viewpoint images.

### BRIEF DESCRIPTION OF THE DRAWINGS

FIG. 1 is a flowchart illustrating a process of creating a final intermediate-viewpoint image;

FIG. 2 is a flowchart illustrating a process of interpolating a missing portion according to a first embodiment;

FIG. 3 is a flowchart illustrating a process of interpolating a missing portion according to a second embodiment;

FIG. 4 is a flowchart illustrating a process of interpolating a missing portion according to a first variation of the second embodiment;

FIG. 5 is a flowchart illustrating a process of interpolating a missing portion according to a second variation of the second embodiment;

FIG. 6 is a flowchart illustrating a process of interpolating a missing portion according to a third embodiment;

FIG. 7 is a flowchart illustrating a process of interpolating a missing portion according to a fourth embodiment;

FIG. 8 is a block diagram illustrating an image processing apparatus for implementing the first to fourth embodiments; and

FIG. 9 is a diagram for illustrating creation of an intermediate-viewpoint image by forward mapping.

### DETAILED DESCRIPTION OF THE PREFERRED EMBODIMENTS

Preferred embodiments of the image processing apparatus, a method, and a recording medium according to the presently disclosed subject matter will be described with reference to the accompanying drawings.

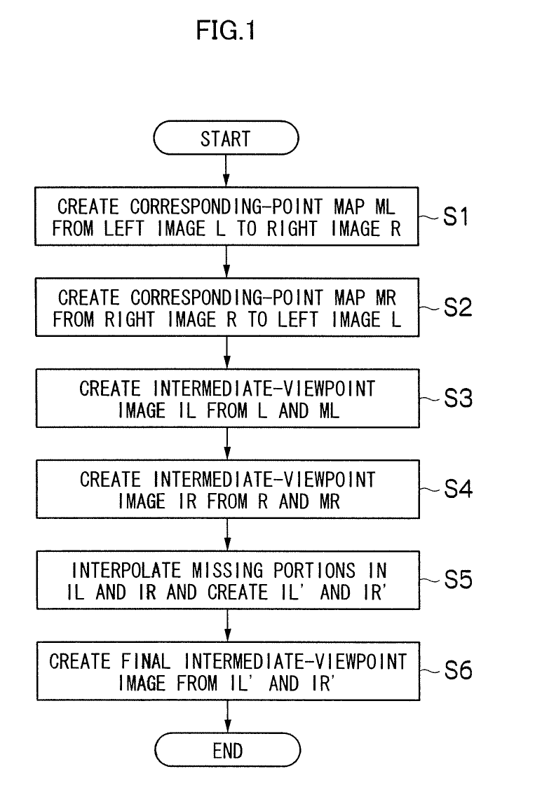

To start with, how to create a final intermediate-viewpoint image will be described with FIG. 1.

First, with a left image L and a right image R having different viewpoints, a corresponding-point map ML from the left image L to the right image R is created (step S1). The corresponding-point map ML is created by searching for pixels in the right image R that correspond to the pixels of the left image L by stereo matching as mentioned above. In a similar manner, a corresponding-point map MR from the right image R to the left image L is created (step S2).

Then, an intermediate-viewpoint image IL that is based on the left image L is created from the left image L and the corresponding-point map ML (step S3). The intermediate-viewpoint image IL is created by multiplying each value in the corresponding-point map ML by a coefficient appropriate for the position of the intermediate viewpoint to be generated and moving the pixels in the left image L by an amount of movement represented by the result of the multiplication. In a similar way, an intermediate-viewpoint image IR based on the right image R is created from the right image R and the corresponding-point map MR (step S4).

Further, missing portions in the intermediate-viewpoint images IL and IR are interpolated and intermediate-viewpoint images IL′ and IR′ are created (step S5). Interpolation of a missing portion will be described in detail later.

Finally, the respective pixels of the intermediate-viewpoint images IL′ and IR′ are weighted-averaged according to the position of the intermediate viewpoint to generate the final intermediate-viewpoint image (step S6).

Because of interpolation of missing portions in the intermediate-viewpoint images IL and IR at step S5, unevenness in color resulting from absence of pixels in one of the intermediate-viewpoint images IL and IR is reduced in the final intermediate-viewpoint image thus created. In the following, interpolation of missing portions in the intermediate-viewpoint images IL and IR will be described.

### First Embodiment

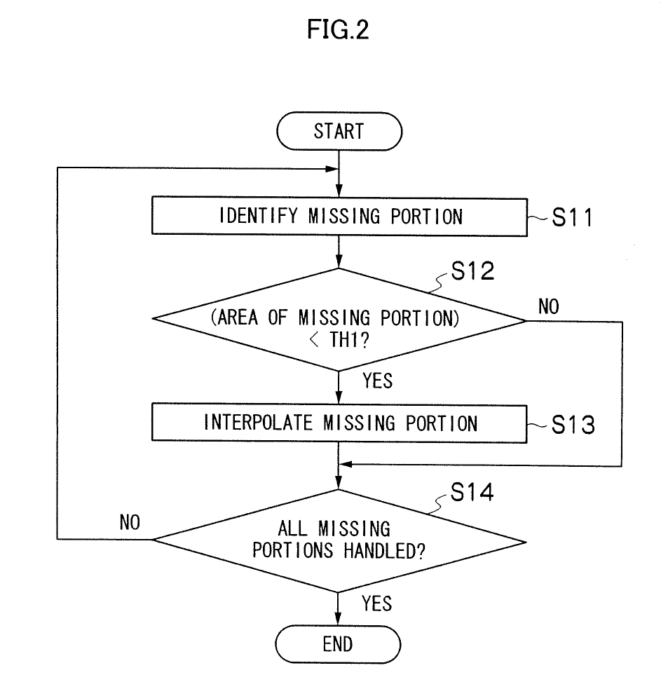

FIG. 2 is a flowchart illustrating a process of interpolating missing portions according to a first embodiment.

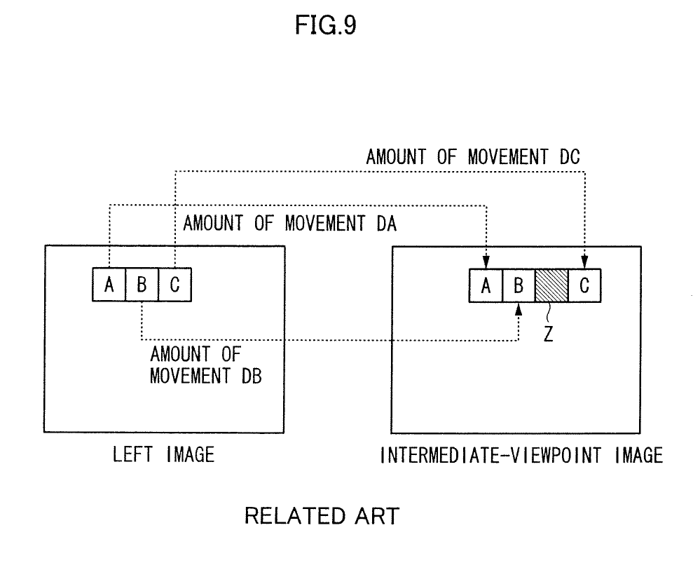

First, a missing portion is identified in the intermediate-viewpoint image IL which is based on the left image L (step S11). A missing portion refers to a portion or region in which a pixel corresponding to a reference image is not laid within an intermediate-viewpoint image due to difference in the amount of movement between neighboring pixels during forward mapping for creating an intermediate-viewpoint image, like region Z illustrated in FIG. 9.

Then, the area of the missing portion identified is calculated, and it is determined whether the area is smaller than a threshold TH1 or not (step S12). Although the region Z in FIG. 9 is illustrated as being only one pixel in size in the vertical direction of the intermediate-viewpoint image IL, an actual missing portion can be present spreading in the vertical direction. In this way, the area of a missing portion that is continuously present is calculated.

In general, when the area of a missing portion is large, the missing portion is considered to be an occlusion region. In this case, it is not desirable to interpolate the missing portion because the image can possibly collapse. Conversely, when the area of a missing portion is small, the missing portion can be ascribed to an error in extracting corresponding points (erroneous correspondence), which is apt to occur especially in a flat image. In such a case, there will be no adverse effect if the missing portion is interpolated using surrounding pixels and the missing portion should be interpolated for the sake of image quality.

The threshold TH1 accordingly depends on the maximum of the area of a missing portion that occurs as a result of an error in extracting corresponding point, and may be appropriately determined according to the parallax between the left image L and the right image R and/or resolution. For example, the threshold TH1 is set to 10 pixels and determination is made as to whether the area of a missing portion is smaller than 10 pixels or not.

If the area of the missing portion identified is smaller than the threshold TH1, the missing portion is interpolated using pixels in the intermediate-viewpoint image IL that surround the missing portion (step S13). For example, the missing portion Z illustrated in FIG. 9 can be interpolated using pixels B and C. In this example, it is preferable that each pixel in the missing portion Z be interpolated with the values of pixels B and C weighted according to the distance from pixels B and C. When pixels above and below the missing portions Z are not missing portions, those pixels may be used to interpolate the missing portion Z. Furthermore, in addition to pixels neighboring the missing portion Z, surrounding pixels positioned two or more pixels away from the missing portion Z may be used for interpolation.

When the area of the missing portion is equal to or larger than the threshold TH1, it is determined that an error or collapse associated with interpolation is likely to occur, and the flow proceeds to step S14 without performing interpolation.

Then, it is determined whether all missing portions in the intermediate-viewpoint image IL have been handled (step S14). If there is any missing portion not handled (interpolated) yet, the flow returns to step S11, where a similar process is performed.

When all missing portions in the intermediate-viewpoint image IL have been handled (interpolated), creation of the intermediate-viewpoint image IL′ is complete. In a similar manner, missing portions in the intermediate-viewpoint image IR which is based on the right image R are interpolated and an intermediate-viewpoint image IR′ is created.

Such interpolation of missing portions reduces unevenness in color in the final intermediate-viewpoint image arising from pixels being present only in one of the two intermediate-viewpoint images. Also, by calculating the area of a missing portion, only missing portions that have less adverse effect associated with interpolation can be eliminated. Besides, these advantages can be gained with one mapping operation on each of the intermediate-viewpoint images, without having to perform mapping twice as in Japanese Patent Application Laid-Open No. 2006-65862.

Although the present embodiment creates an image corresponding to a viewpoint intermediate between the viewpoints of the left- and right-viewpoint images as inputs, this embodiment can be similarly implemented with images taken at three or more viewpoints (i.e., three or more images) to provide equivalent effects.

### Second Embodiment

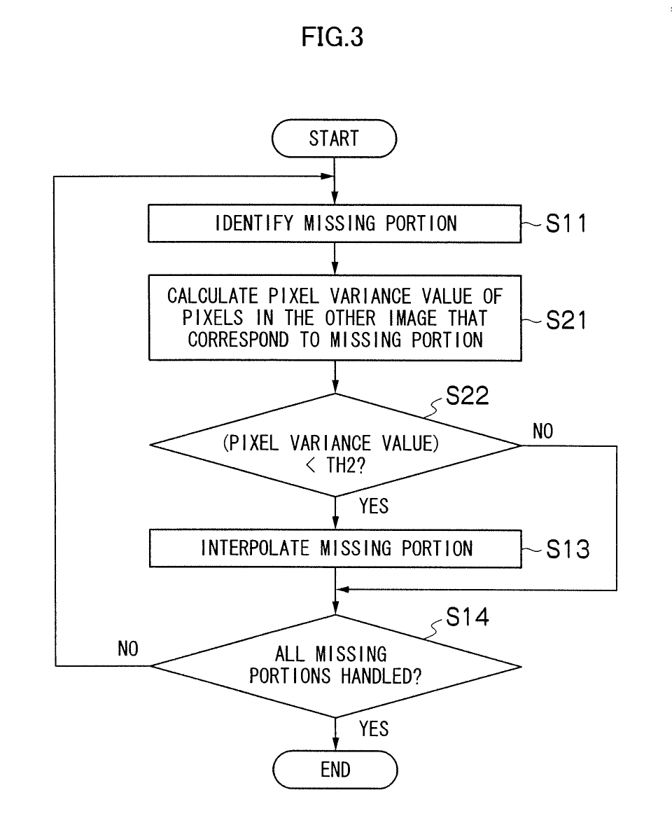

FIG. 3 is a flowchart illustrating a process of interpolating missing portions according to a second embodiment. Steps common to the flowchart of FIG. 2 are given the same reference numerals and their detailed descriptions are omitted.

As in the first embodiment, a missing portion is identified in the intermediate-viewpoint image IL which is based on the left image L (step S11).

Then, a region corresponding to the missing portion identified at step S11 (i.e., a region at the same coordinate position as the missing portion) is extracted from the intermediate-viewpoint image IR which is based on the right image R, and a pixel variance value is calculated from the pixel values (luminance values) of pixels in the region (step S21). The pixel variance value may also be derived from the right image R, in which case a region in the right image R corresponding to the missing portion is identified and extracted through coordinate transformation.

Determination is made as to whether the pixel variance value is smaller than a threshold TH2 or not (step S22).

When the pixel variance value of the region corresponding to the missing portion is large, the region is considered to have a high contrast and the missing portion will also have a high contrast. Therefore, unevenness in color caused by the missing portion is not conspicuous and the missing portion need not be interpolated. Conversely, when the pixel variance value is small, the contrast of the missing portion is also likely to be low, which makes unevenness in color conspicuous. Thus, in this case, the missing portion should be interpolated. Accordingly, the threshold value TH2 may be appropriately set to a value that allows a region to be regarded as flat.

If the pixel variance value is smaller than the threshold value TH2, the missing portion is interpolated using surrounding pixels (step S13). If the pixel variance value is equal to or greater than the threshold value TH2, interpolation is not performed and the flow proceeds to step S14.

Then, it is determined whether all missing portions in the intermediate-viewpoint image IL have been handled (step S14). If any of the missing portions has not been handled yet, the flow returns to step S11, where a similar process is performed.

When all the missing portions in the intermediate-viewpoint image IL have been handled, missing portions in the intermediate-viewpoint image IR which is based on the right image R are interpolated in a similar manner. Through these processes, intermediate-viewpoint images IL′ and IR′ are created.

As described above, with two intermediate-viewpoint images for generating the final intermediate-viewpoint image, by calculating a pixel variance value of a region in one of the intermediate-viewpoint image that corresponds to a missing portion in the other intermediate-viewpoint image, it is determined whether the region is flat or not. If the region is flat, in which unevenness in color can be conspicuous, the missing portion is interpolated.

Although the present embodiment uses a pixel variance value for luminance values of pixels for determination, a pixel variance values based on color components such as RGB (Red, Green and Blue)) may be used. Alternatively, standard deviation may be used instead of variance. Further, the difference between the maximum and the minimum of pixel values of pixels may be used for determination.

### Variations of the Second Embodiment

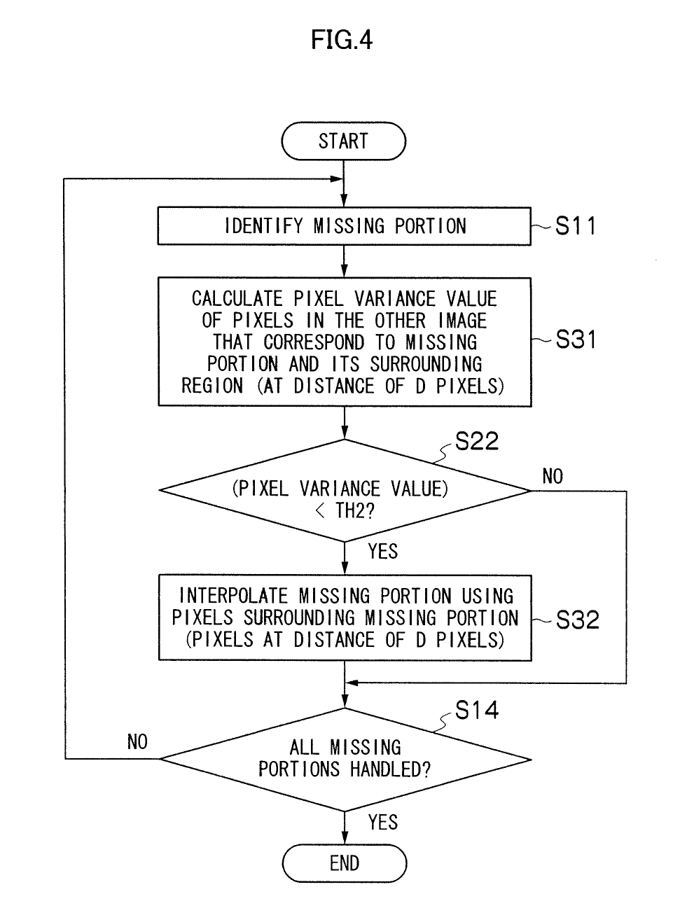

FIG. 4 is a flowchart illustrating a process of interpolating a missing portion in a first variation of the second embodiment. The first variation is different from the second embodiment illustrated in FIG. 3 in that, for a missing portion identified in one of two images, a pixel variance value is calculated in a different region in the other image from the second embodiment.

This variation extracts a region corresponding to the missing portion identified at step S11 as well as a surrounding region (a region of a range at a predetermined distance of D pixels) in the intermediate-viewpoint image IR which is based on the right image R, and derives a pixel variance value from pixel values of pixels in those regions (step S31).

When the pixel variance value derived is smaller than the threshold value TH2, the missing portion is interpolated, also for which pixels within the range at the distance of D pixels are used (step S32).

For instance, in the example illustrated in FIG. 9, pixel B and pixel C can represent totally different subjects. In such a case, it may be not preferable to interpolate the missing portion Z using pixels B and C. According to the present embodiment, because determination on whether the missing portion should be interpolated or not employs a pixel variance value from not only the region corresponding to missing portion Z but regions corresponding to pixels B and C, which are regions surrounding the missing portion Z, it is possible to decide not to interpolate the missing portion when it is not preferable to do so.

As described, accuracy of determination can be enhanced by identifying an image characteristic using pixels in the region corresponding to a missing portion (i.e., the region at the same coordinate position) as well as surrounding pixels.

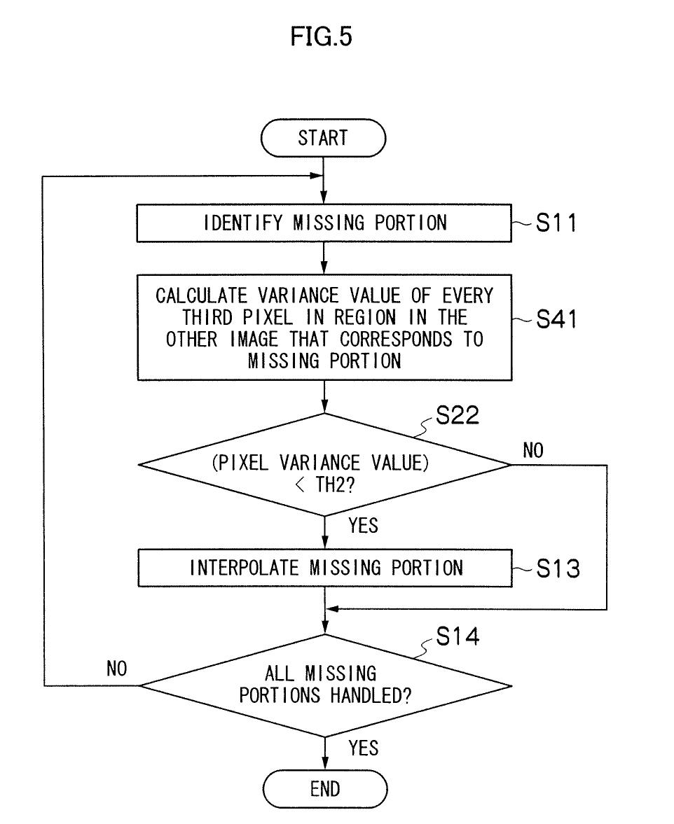

FIG. 5 is a flowchart illustrating a process of interpolating a missing portion according to a second variation of the second embodiment. This variation is different from the second embodiment illustrated in FIG. 3 in that it derives a pixel variance value with pixels thinned out.

As in the second embodiment, a missing portion is identified in the intermediate-viewpoint image IL which is based on the left image L (step S11), and a region corresponding to the missing portion is extracted in the intermediate-viewpoint image IR which is based on the right image R.

Here, while the second embodiment derives a pixel variance value from all pixels contained in the extracted region, this variation obtains a pixel variance value from pixel values of every three pixels in the extracted region (step S41). It is determined whether the pixel variance value is smaller than the threshold TH2 (step S22). If the pixel variance value is smaller than threshold TH2, the missing portion is interpolated using surrounding pixels (step S13).

Thus, by obtaining pixel values of every three pixels, a pixel variance value can be computed with less load. The number of computations can be decreased by further increasing the thinning rate, but deviation from a variance value for a region that corresponds to the actual missing portion can be large: the thinning rate and accuracy of determination are a tradeoff.

The first variation may be combined with the second variation so that pixels in the missing-portion region and surrounding pixels are thinned out when deriving pixel values and calculating a pixel variance value.

### Third Embodiment

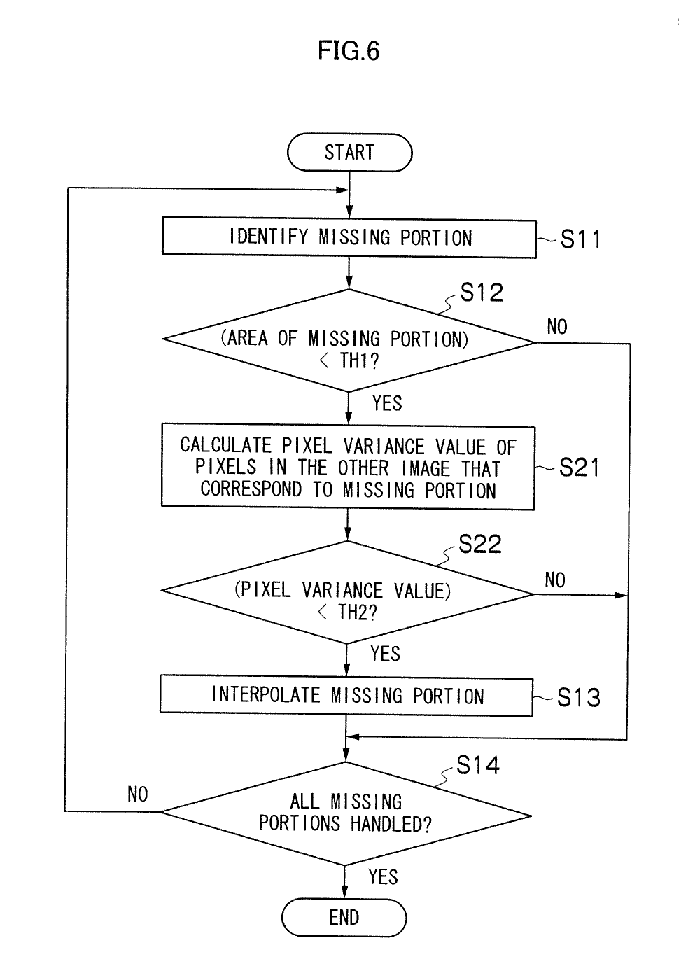

FIG. 6 is a flowchart illustrating a process of interpolating a missing portion according to a third embodiment. According to the third embodiment, the area and a variance value of a missing portion are determined before interpolation of the missing portion.

As in the previous embodiments, a missing portion is identified in the intermediate-viewpoint image IL which is based on the left image L (step S11).

Then, the area of the missing portion is calculated and it is determined whether the area is smaller than the threshold value TH1 (step S12).

If the area of the missing portion is equal to or larger than the threshold value TH1, it is determined that an error associated with interpolation is likely to occur, and the flow proceeds to step S14 without performing interpolation.

If the area of the missing portion is smaller than the threshold value TH1, a region corresponding to the missing portion identified at step S11 is extracted from the intermediate-viewpoint image IR which is based on the right image R, and a pixel variance value is calculated from pixel values of the pixels in the region (step S21). It is then determined whether the pixel variance value is smaller than the threshold value TH2 (step S22).

When the pixel variance value is equal to or greater than the threshold value TH2, it is determined that an error associated with interpolation is likely to occur and the flow proceeds to step S14 without performing interpolation. If the pixel variance value is smaller than the threshold value TH2, it is determined that the missing portion is not an occlusion region because its area is small and that the image is flat because the pixel variance value is small, and the missing portion is interpolated using surrounding pixels (step S13).

It is then determined whether all the missing portions in the intermediate-viewpoint image IL have been handled (step S14). If any missing portion has not been handled (interpolated) yet, the flow returns to step S11, where a similar process is performed.

When all missing portions in the intermediate-viewpoint image IL have been handled (interpolated), missing portions in the intermediate-viewpoint image IR based on the right image R are interpolated in a similar manner. Through these processes, the intermediate-viewpoint images IL′ and IR are created.

As described above, for a missing portion identified, determination is made first based on its area and determination on pixel variance value is performed only when the area of the missing portion is small. Thereby, only missing portions that have occurred due to an error in extracting corresponding point (erroneous correspondence) and that are regions representing a flat image can be interpolated. In addition, processing time can be shortened because high-load computations of a pixel variance value can be minimized.

Although the present embodiment performs determinations based on area (Yes in step S12) and pixel variance value (Yes in step S22) for a missing portion and performs interpolation when both conditions (i.e., Yes in both steps S12 and S22 in FIG. 6) are satisfied, interpolation may be performed when only one of the two conditions (i.e., Yes in steps S12 or S22 in FIG. 6) is satisfied. In this case, it is possible to interpolate both a missing portion that results from an error in extracting corresponding points (i.e., erroneous correspondence) and a missing portion which probably represents a flat image.

### Fourth Embodiment

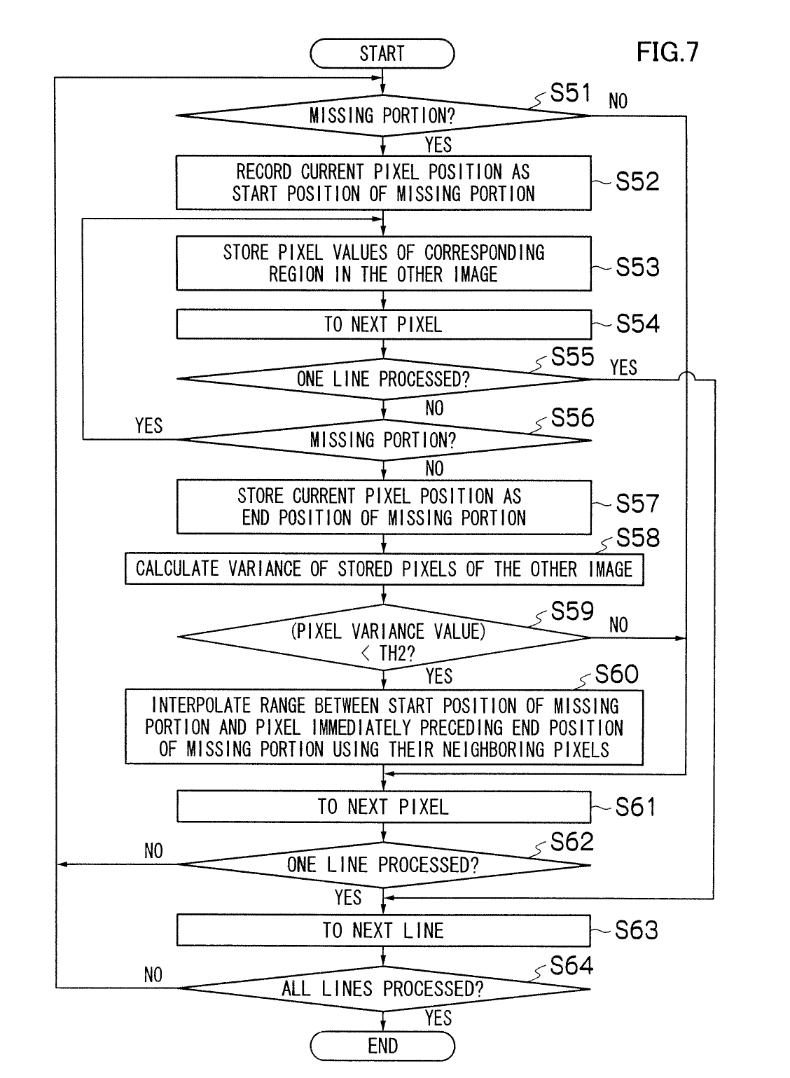

FIG. 7 is a flowchart illustrating a process of interpolating missing portions according to a fourth embodiment. The present embodiment interpolates missing portions on each horizontal pixel line.

First, it is determined whether the leftmost pixel P(0, 0) on a horizontal line L(0) that is positioned at the top of the intermediate-viewpoint image IL is a missing portion or not (step S51).

If the pixel is not a missing portion, the flow proceeds to step S61. Then, it is determined whether a next pixel P(1,0) (a right neighbor of the pixel P(0,0)) on the horizontal line L(0) is a missing portion or not (step S51).

It is determined whether processing is completed for all the pixels P(0,0), . . . , P(m,0) on the horizontal line L(0) (step S62). If the processing is not completed yet (No in step S62), the flow returns to step S51, where it is determined whether the next pixel P(2, 0) is a missing portion. Thereafter, the flow proceeds to the next right pixel and a similar process is repeated until it is determined that the current pixel P(i,j) is a missing portion.

If it is determined that the pixel P(i,j) is a missing portion at step S51, then at step S52 the position of the pixel P(i,j) is stored as a start position of the missing portion and further the pixel values of pixels in the intermediate-viewpoint image IR that correspond to the missing portion are stored (step S53).

The flow then proceeds to the next right pixel (step S54), and it is determined whether processing is completed for the entire horizontal line (step S55).

If processing is not complete for all the horizontal line, it is determined whether the pixel is a missing portion (step S56). If the pixel is a missing portion, the flow returns to step S53, where the pixel values of pixels in the intermediate-viewpoint image IR that correspond to the missing portion are stored. Then, a similar process is repeated on the next right pixel.

When the contiguous missing portion ends, it is determined at step S56 that the pixel P(i+k,j) is not a missing portion, and the flow proceeds to step S57. The current pixel position is recorded as the end position of the missing portion (step S57), and a variance of the stored pixel values of pixels in the intermediate-viewpoint image IR is calculated (step S58).

It is determined whether the pixel variance value is smaller than threshold value TH2 (step S59).

If the pixel variance value is smaller than threshold value TH2, the range between the starting position of the missing portion and a pixel immediately preceding the end position is interpolated using pixels at both ends (i.e., the neighboring pixel P(i-1,j) on the left of the starting position P(i,j) and the pixel P(i+k,j) at the end position) (step S60). Alternatively, two or more pixels on each of the right and left sides may be used for interpolation, instead of one pixel.

If the pixel variance value is equal to or greater than the threshold value TH2, interpolation is not performed and the flow proceeds to step S61 to move on to the next right pixel.

It is then determined whether the entire horizontal line L(0) has been processed (step S62). If the entire horizontal line L(0) has not been processed, the flow returns to step S51 to repeat a similar process.

When it is determined that the entire horizontal line L(0) has been processed at step S55 or S62, the flow proceeds to the next line L(1) below (step S63). From the leftmost pixel P(0,1) in the line L(1), determination on whether the pixel is a missing portion is performed again (step S51).

When handling of missing portions is complete for all horizontal lines L(0), . . . , L(n) in the intermediate-viewpoint image IL (step S64), missing portions in the intermediate-viewpoint image IR which is based on the right image R are interpolated in a similar manner. Through these processes, the intermediate-viewpoint images IL′ and IR′ are created.

By thus performing processing on each horizontal line, interpolation is simplified and computation load can be reduced. Although the present embodiment interpolates missing portions on each horizontal line, interpolation may be performed on each vertical line. In addition, although the present embodiment performs determination on pixel variance value for an identified missing portion before interpolation, determination on area may be performed as in the first embodiment.

### <Configuration of Image Processing Apparatus>

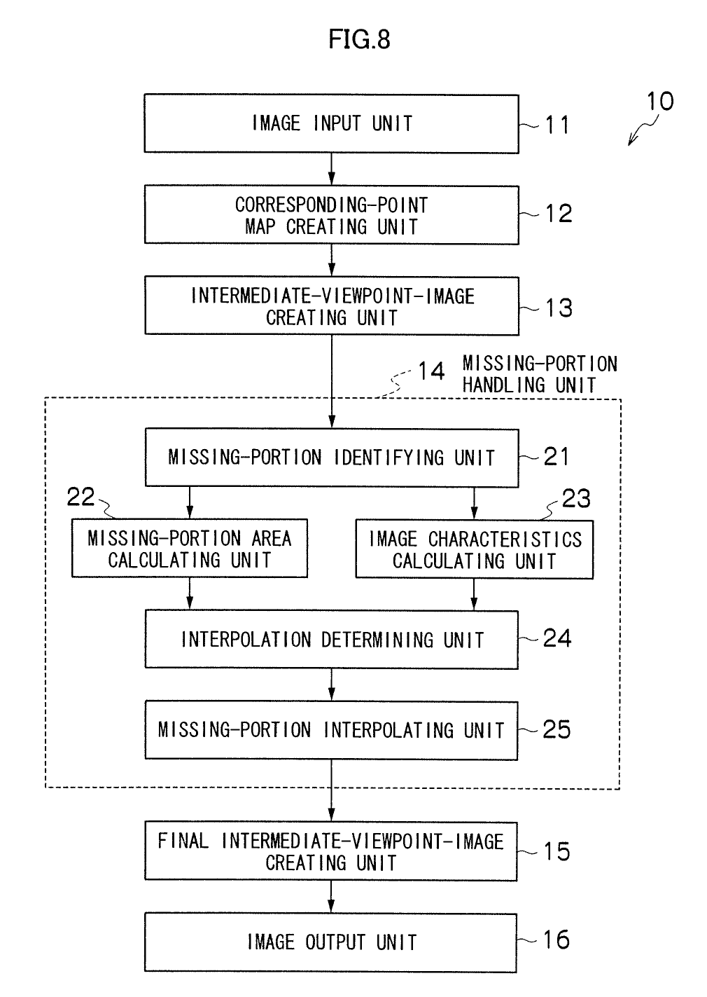

FIG. 8 is a block diagram illustrating an image processing apparatus 10 for implementing the first to fourth embodiments. The image processing apparatus 10 is configured by a personal computer or a work station, for example, and includes an image input unit 11, a corresponding-point map creating unit 12, an intermediate-viewpoint-image creating unit 13, a missing-portion handling unit 14, a final intermediate-viewpoint-image creating unit 15, and an image output unit 16.

The image input unit 11 accepts input of a left image L and a right image R taken as a stereo image, corresponding to an image reading device for reading a multi-image or multi-picture file (an MP file) from a recording medium in which an MP file concatenating multi-viewpoint images for a stereo image is recorded or a device for retrieving an MP file over a network, for example.

The corresponding-point map creating unit 12 prepares a corresponding-point map ML from the left image L to the right image R and a corresponding-point map MR from the right image R to the left image L by stereo matching with the left image L and right image R input to the image input unit 11.

The intermediate-viewpoint-image creating unit 13 creates the intermediate-viewpoint image IL based on the left image L using the left image L and corresponding-point map ML, and creates the intermediate-viewpoint image IR based on the right image using the right image R and the corresponding-point map MR.

The missing-portion handling unit 14 includes a missing-portion identifying unit 21, a missing-portion area calculating unit 22, an image characteristics calculating unit 23, interpolation determining unit 24, and a missing-portion interpolating unit 25.

The missing-portion identifying unit 21 identifies missing portions in the intermediate-viewpoint images IL and IR.

The missing-portion area calculating unit 22 calculates the area of a missing portion identified by the missing-portion identifying unit 21.

The image characteristics calculating unit 23 extracts a region corresponding to a missing portion identified by the missing-portion identifying unit 21 from a corresponding image, and derives a pixel variance value from pixel values of pixels in the region. The image characteristics calculating unit 23 may be configured to calculate a standard deviation or the difference between the maximum and the minimum of the pixels instead of a pixel variance value.

Only one of the missing-portion area calculating unit 22 and the image characteristics calculating unit 23 may be included according to an embodiment to be implemented.

The interpolation determining unit 24 determines whether a missing portion should be interpolated or not based on the result of calculation by the missing-portion area calculating unit 22 and/or the image characteristics calculating unit 23.

The missing-portion interpolating unit 25 interpolates a missing portion using surrounding pixels based on the result of determination by the interpolation determining unit 24, and creates intermediate-viewpoint images IL′ and IR′ from the intermediate-viewpoint images IL and IR, respectively.

The final intermediate-viewpoint-image creating unit 15 weighted-averages the pixels of the intermediate-viewpoint images IL′ and IR′ according to intermediate viewpoint position to create a final intermediate-viewpoint image.

The image output unit 16 corresponds to a stereo photoprint creating unit or a 3D (three dimensional) monitor, to which the final intermediate-viewpoint image created by the final intermediate-viewpoint-image creating unit 15 is output.

Although the process of interpolation is entirely implemented by hardware herein, the process may be implemented in an interpolation program for controlling the image processing apparatus 10.

The presently disclosed subject matter can be provided as a computer-readable program code for causing a device (such as an electronic camera or a computer) to execute the above described process, a non-transitory computer-readable recording medium (for example, an optical disc such as a CD (Compact Disc), a DVD (Digital Versatile Disc) and a BD (Blu-ray Disc), a magnetic disc such as a hard disc, a magneto-optical disc) on which the computer-readable program code is stored or a computer program product including the computer-readable program code.

What is claimed is:

1. An image processing method executed in an image processing apparatus, comprising:
an image input step of inputting a left-viewpoint image and a right-viewpoint image that have a parallax therebetween to the image processing apparatus;
a step of searching for a corresponding point in the right-viewpoint image for each pixel with respect to the left-viewpoint image, generating a first corresponding-point map based on a result of the searching, and generating a first intermediate-viewpoint image which is based on the left-viewpoint image by forward mapping performed according to the first corresponding-point map;
a step of searching for a corresponding point in the left-viewpoint image for each pixel with respect to the right-viewpoint image, generating a second corresponding-point map based on a result of the searching, and generating a second intermediate-viewpoint image which is based on the right-viewpoint image by forward mapping performed according to the second corresponding-point map;
an extracting step of extracting missing portions of pixels in the first and second intermediate-viewpoint images, the missing portions being caused by absence of corresponding pixels in the forward mapping;
a determination step of determining whether a missing portion extracted is a missing portion to be interpolated or not;
an interpolating step of interpolating the missing portion to be interpolated based on a result of determination in the determination step; and
a step of generating a third intermediate-viewpoint image based on the first and second intermediate-viewpoint images.

2. The image processing method according to claim 1, wherein
the determination step determines, for a first missing portion in the first intermediate-viewpoint image, whether the first missing portion is a missing portion to be interpolated based on an image characteristic of a predetermined region in the second intermediate-viewpoint image, and
the determination step determines, for a second missing portion in the second intermediate-viewpoint image, whether the second missing portion is a missing portion to be interpolated based on an image characteristic of a predetermined region in the first intermediate-viewpoint image.

3. The image processing method according to claim 2, wherein
the predetermined regions in the first and second intermediate-viewpoint image are regions corresponding to the first and second missing portions, respectively.

4. The image processing method according to claim 2, wherein
the predetermined regions in the first and second intermediate-viewpoint image are regions corresponding to the first and second missing portions and a surrounding regions of the first and second missing portions, respectively, and
the interpolating step interpolates the first and second missing portions using pixels in a regions corresponding to the surrounding region thereof, respectively.

5. The image processing method according to claim 2, wherein
the image characteristic is a variance or standard deviation of pixel values of pixels, or a difference between a maximum and a minimum of pixel values of the pixels.

6. The image processing method according to claim 2, wherein
the image characteristic is a variance or standard deviation of pixel values of pixels at a predetermined interval, or a difference between a maximum and a minimum of pixel values of pixels at a predetermined interval.

7. The image processing method according to claim 1, wherein
the determination step determines whether the missing portion extracted is a missing portion to be interpolated or not according to a size of the missing portion.

8. The image processing method according to claim 7, wherein
the determination step determines whether the missing portion extracted is a missing portion to be interpolated or not based on the size of the missing portion, and
among missing portions to be interpolated as determined in the determination step, for a first missing portion in the first intermediate-viewpoint image, the determination step further determines whether the first missing portion is a missing portion to be interpolated or not based on an image characteristic of a predetermined region in the second intermediate-viewpoint image, and for a second missing portion in the second intermediate-viewpoint image, the determination step further determines whether the second missing portion is a missing portion to be interpolated or not based on an image characteristic of a predetermined region in the first intermediate-viewpoint image.

9. The image processing method according to claim 1, wherein
the extracting step extracts a missing portion on each horizontal or vertical line in the first and second intermediate-viewpoint images,
the determination step determines whether the missing portion extracted on each line is a missing portion to be interpolated or not, and
the interpolating step interpolates the missing portion to be interpolated on each line using at least pixels at both ends of the missing portion.

10. An image processing apparatus comprising:
an image input device configured to receive an input of a left-viewpoint image and a right-viewpoint image that have a parallax therebetween;
a first search device configured to search for a corresponding point in the right-viewpoint image for each pixel with respect to the left-viewpoint image, generate a first corresponding-point map based on a result of the search, and generate a first intermediate-viewpoint image which is based on the left-viewpoint image by forward mapping performed according to the first corresponding-point map;
a second search device configured to search for a corresponding point in the left-viewpoint image for each pixel with respect to the right-viewpoint image, generates a second corresponding-point map based on a result of the search, and generates a second intermediate-viewpoint image which is based on the right-viewpoint image by forward mapping performed according to the second corresponding-point map;
an extracting device configured to extract missing portions of pixels in the first and second intermediate-viewpoint images, the missing portions being caused by absence of corresponding pixels in the forward mapping;
a determining device configured to determine whether a missing portion extracted is a missing portion to be interpolated or not;
an interpolating device configured to interpolate the missing portion to be interpolated based on a result of determination by the determination device; and
a generating device configured to generate a third intermediate-viewpoint image based on the first and second intermediate-viewpoint images.

11. A computer-readable recording medium including an image processing program stored thereon, such that when the image processing program is read and executed by a processor of an image processing apparatus, the processor is configured to execute:
an image input function of inputting a left-viewpoint image and a right-viewpoint image that have a parallax therebetween to the image processing apparatus;
a function of searching for a corresponding point in the right-viewpoint image for each pixel with respect to the left-viewpoint image, generating a first corresponding-point map based on a result of the searching, and generating a first intermediate-viewpoint image which is based on the left-viewpoint image by forward mapping performed according to the first corresponding-point map;
a function of searching for a corresponding point in the left-viewpoint image for each pixel with respect to the right-viewpoint image, generating a second corresponding-point map based on a result of the searching, and generating a second intermediate-viewpoint image which is based on the right-viewpoint image by forward mapping performed according to the second corresponding-point map;
an extracting function of extracting missing portions of pixels in the first and second intermediate-viewpoint images, the missing portions being caused by absence of corresponding pixels in the forward mapping;
a determination function of determining whether a missing portion extracted is a missing portion to be interpolated or not;
an interpolating function of interpolating the missing portion to be interpolated based on a result of determination by the determination function; and
a function of generating a third intermediate-viewpoint image based on the first and second intermediate-viewpoint images.
